(19) United States
(12) Patent Application Publication
(10) Pub. No.: US 2016/0064911 A1
(43) Pub. Date: Mar. 3, 2016

(54) CANTILEVER FOR OVERHEAD CONTACT LINE

(71) Applicant: PFISTERER UPRESA, S.A., Barcelona (ES)

(72) Inventors: Thierry Metrat, Barcelona (ES); Raul Nadal Moreno, Barcelona (ES)

(73) Assignee: PFISTERER UPRESA, S.A., Barcelona (ES)

(21) Appl. No.: 14/784,003

(22) PCT Filed: Apr. 7, 2014
(86) PCT No.: PCT/ES2014/070270

§ 371 Date: Oct. 12, 2015

(30) Foreign Application Priority Data
Apr. 10, 2013 (ES) P201330512

(51) Int. Cl. H02G 7/05; B60M 1/20

(52) U.S. Cl. CPC H02G 7/05; B60M 1/20

(57) ABSTRACT

The invention relates to a cantilever for an overhead line, of the type comprising a main cantilever beam that receives the elements for securing the wires of the overhead line located at its distal end and a diagonal beam supporting the main beam and inclined in relation to same. The main beam is telescopic and comprises a proximal portion and a distal portion that can move telescopically in relation to one another. The above-mentioned wire-securing elements are secured in the distal portion. The diagonal beam is connected to the horizontal beam in the proximal portion thereof, by means of a rotatable coupling. In addition, the diagonal beam is telescopic.

The present invention relates to a cantilever for an overhead line.

A cantilever for an overhead line is a beam or assembly of elements for supporting the overhead line of a railway, tram or trolleybus system. It is generally secured to posts but in special situations can be supported on walls, façades or columns.

Usually, direct-current overhead lines are separated from the cantilevers by means of insulators, whereas in alternating-current lines the insulators are usually located in the support to which the overhead line is secured (posts, wall, etc.).

Cantilevers are so called because they are structures that project in cantilever fashion from the element on which they are mounted (generally a post). Their function is to support the elements of the overhead line in their correct position above the train. Generally speaking, the overhead line comprises at least two wires: the contact wire and the messenger wire that supports it. The cantilever has to support both wires in their correct position. The correct position of the overhead wires, with respect to the railway line, referred to the horizontal plane, varies from one support to the next in order to reduce wear on the pantograph, for which reason the point of fixation of the wires varies between contiguous cantilevers.

Due to the lack of standardisation, and the size and weight of the elements that make up the invention, the installation of cantilevers for overhead lines is a labour-intensive task, in which the labour itself represents the main cost of the work. In fact, two teams of workers are necessary for the placement of the cantilevers: a fitting team and another team with measuring apparatus to ensure that the cantilever is in the correct position.

An aim of the present invention is to disclosure a cantilever for an overhead line that requires only a single team for its installation.

In particular, the present invention relates to a cantilever for an overhead line, of the type comprising a main cantilever beam that receives the elements for securing the wires of the overhead line located at its distal end and a diagonal beam supporting the main beam and inclined in relation to same, characterised in that:
the main beam is telescopic and comprises a proximal portion and a distal portion that can move telescopically in relation to one another;
the said wire-securing elements are fixed in the distal portion;
the said diagonal beam is connected to the horizontal beam by means of a rotatable coupling;
the said diagonal beam is also telescopic.

The diagonal beam may be joined to the horizontal beam either in its proximal portion or in its distal portion.

Preferably, the distal portion of the main beam can slide freely inside the proximal portion, the beam being provided with an adjustment device that allows the position of the distal portion of the beam to be fixed within a continuous spectrum of adjustment positions.

More preferably, the adjustment device comprises a groove in the proximal portion of the main beam and at least one bolt that passes through the said groove and makes contact with the distal portion of the main beam.

The said hole may be a threaded bore located in a piece in the end of the distal portion of the main beam.

Even more preferably, the said bolt is inserted into a threaded hole in the distal portion of the main beam. Equally preferably, the adjustment device also comprises a sleeve that shrouds the proximal portion of the main beam, with the ability to slide along the same.

In addition, the present invention provides for the adjustment device also to comprise a locking joint ring or washer to fit the head of the bolt.

Preferably, the supporting elements of the cables of the overhead line are joined to the distal portion at dedicated and unique points of the said distal portion.

According to the present invention, the distal portion may have a scale that indicates the offset of the overhead line with respect to the axis of the guide, for example by indicating the said distance or another indirect distance.

In addition, the present invention also provides for the main beam and the proximal beam to be joined to a fixed structure by means of electrical insulators.

By choosing the appropriate morphology and using adjustable telescopic beams, it is possible to situate the overhead lines with precision using a single fitting team.

For a clearer understanding, a number of drawings showing an embodiment of the cantilever forming the subject of the present invention are annexed by way of non-limitative example.

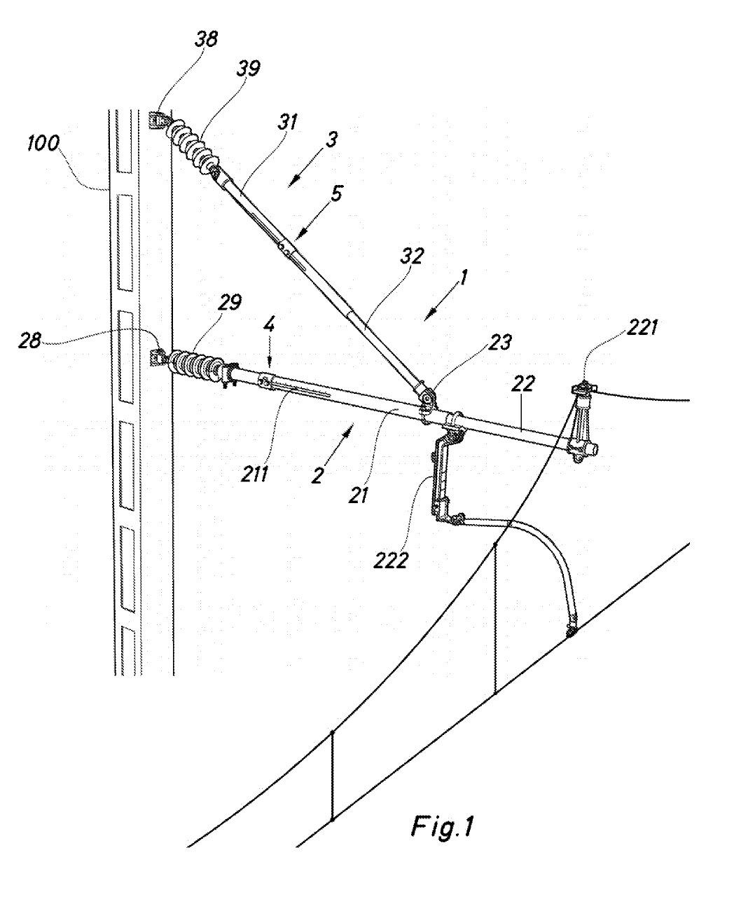

FIG. 1 is a perspective view of an embodiment of a cantilever according to the present invention in “pull-in” (braced inwards) configuration.

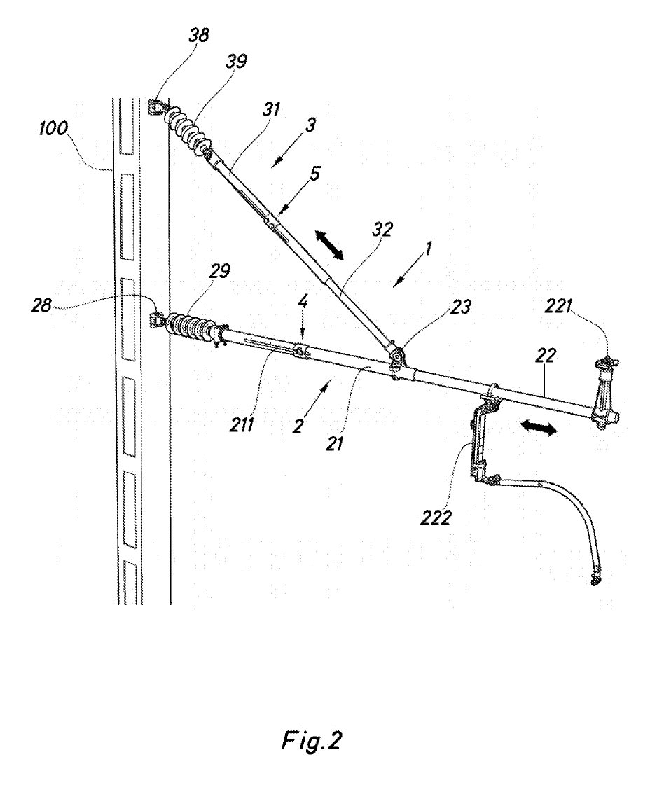

FIG. 2 corresponds to FIG. 1, with a different adjustment of the telescopic beams.

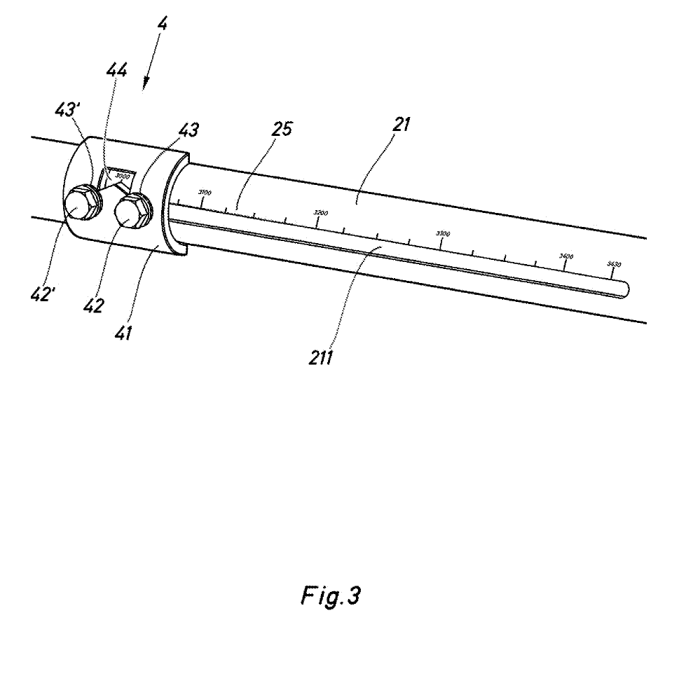

FIG. 3 is a detail of the adjustment part and the associated scale, which shows a distance of the cantilever according to the degree of displacement or extension of the telescopic beam.

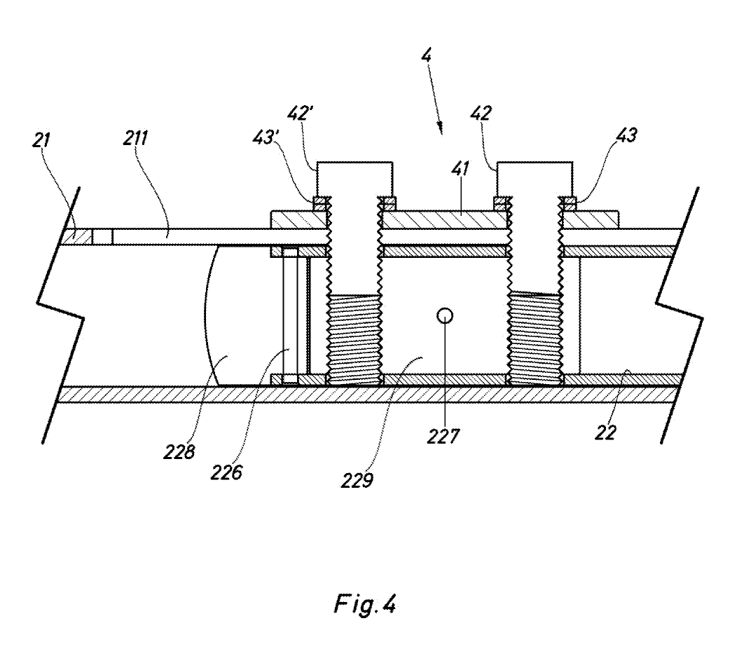

FIG. 4 shows a cross-section of the adjustment device.

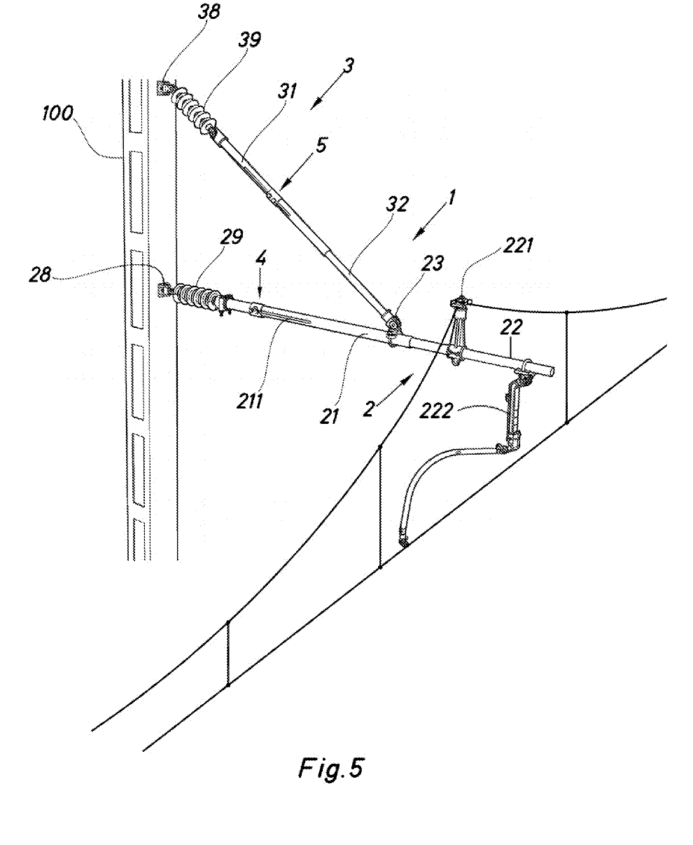

FIG. 5 is a perspective view of an embodiment similar to that of FIG. 1 in “push-off” (braced outwards) configuration.

FIGS. 1 to 3 show an embodiment of an adjustable cantilever.

The cantilever of the example has four main parts:
A tube (corresponding to what is referred to in this description as the proximal portion -21- of the main beam) with a connector, an insulator -29- and a post bracket -28-.
A telescopic tube (corresponding to the distal portion -22- of the main beam) which is inserted into the former and slides outwards with supports -221-, -222- for carrier cable or wire (“steady carrier”) and messenger cable or wire (“MW support”).
A tube (corresponding to the proximal portion -31- of the diagonal beam) with upper insulator and post bracket (-39-, -38-).
A telescopic tube (corresponding to the distal portion of the diagonal beam) which is inserted into the former with fixing accessories.

The unit can be delivered in folded form, or with the parts already assembled. That is to say, with the telescopic tubes already fitted and the connection between the tubes in the folded state, requiring only unfolding and sliding of the telescopic tubes.

A fixing piece with locking washer allows the position of each telescopic beam to be fixed. Ganging scales marked on the proximal portions of the telescopic beam indicate the distance between the post and the overhead line, simplifying installation and adjustment.

It is also possible to add a ganging scale on the upper beam in order to control the length of the said beam (not shown in the drawings).

FIG. 1 shows an example embodiment of the cantilever forming the subject of the present invention.

In this case, the cantilever -1- consists of a cantilevered main beam -2- and a diagonal beam -3- whose function is to cooperate with the main beam -2- in supporting the securing elements -221-, -222- of the overhead line wires (not shown in the drawing).

In the example shown, it can be seen that the securing elements comprise a messenger wire support clip -221- and a conductor wire steady carrier -222- in pull-off configuration. In this case, both elements -221-, -222- are fixed to the main beam -2-, without the possibility of modifying their position. In the case shown, the main beam -2- and the diagonal beam -3- are fixed directly to a post -100- with the sole intermediary of the respective insulators -29- and -39- and of hinged post connections -28- and -38- which allow the relative turning of the beams -2- and -3- with respect to the post -100-.

In a manner characteristic of the present invention, the main beam -2- is a telescopic beam, which comprises a proximal portion -21- and a distal portion -22-. The proximal portion -21- comprises a tube of greater diameter than the tube comprised by the distal portion -22-. Thus, the distal portion -22- can slide freely inside the proximal portion -21-.

The messenger wire support clip -221- and the steady carrier -222- are fixed to the distal portion -22-, while the connection between the main beam -2- and the diagonal beam -3- is made by means of a hinged connection -23-, which allows the oblique angle formed between the main beam -2- and the diagonal beam -3- to be varied when the cantilever is adjusted telescopically.

In another preferred embodiment, not shown, the diagonal beam -3- could be joined to the distal portion -22- of the horizontal beam -2-, for example in the vicinity of the clip -221-.

In addition, and for the same purpose, the diagonal beam -3- is telescopic, with a distal portion -32- that slides inside a proximal portion -31-.

Both the proximal portion -21- of the main beam -2- and the proximal portion -31- of the diagonal beam -3- have, at their ends, the insulators -39-, -29- and hinged connectors -28-, -38- to the post -100-.

The relative position between the proximal portions -21-, -31- and the distal portions -22-, -32- of each beam -2-, -3- is fixed by means of respective adjustment devices -4-, -5-. In the embodiment shown, both adjustment devices -4- and -5- of the main beam and of the diagonal beam are similar, for which reason only the adjustment device -4- of the main beam -2- will be described in greater detail below.

The adjustment device -4- of the hinged main beam -2- of the example shown is designed to provide the cantilever with a continuous range of adjustment positions, and to make adjustment easy and rapid.

For its part, the steady carrier -222- may be, for example, of a known type such as that shown in the drawings, which is provided with a support joined rotatably to the main beam -2- and adjustable in height.

The adjustment device, as can be seen in FIG. 3, comprises externally a bushing -4- (in this case a cut bushing) which slides along the proximal portion -21- and has two locking screws -42- and -42′- with locking washers -43- and -43′- which are inserted via a groove -211- in the proximal portion -21- of the beam -2- until they make contact with the distal portion situated inside the proximal portion -21-. The bushing -41- in its turn has an aperture -44- which allows the reading of a scale -25- situated on the surface of the proximal portion -21-, which indicates a distance relating to the degree of adjustment of the telescopic device, such as, for example, the distance from the post to the clip -221-, which is an indirect measurement of the offset of the overhead line with respect to the axis of the guide at that point. It is also possible for the scale -25- to indicate the said offset directly.

FIG. 4 shows a cross-section of the adjustment device -4-, in which it can be seen that the tube that forms the distal portion is inserted into the tube that forms the proximal portion -21-. The tube that forms the distal portion -22- has at its end a guide plug -228- to facilitate guidance inside the proximal portion -21- and has a drilled part -229- that receives the said locking screws -42-y-42′-. The aforementioned bushing -41- can also be seen, as well as the locking washers -43- and -43′-. Both the drilled part -229- and the guide plug -226- have drill holes -227-, -226- perpendicular to each other in order to ensure correct fitting.

FIG. 5 shows an embodiment of a cantilever similar to that of FIGS. 1 to 3, but in pull-off configuration, for which reason the clip -221- and the steady carrier -222- are in positions which, although fixed, differ from those shown in the aforementioned example of FIGS. 1 to 3. The other elements of FIG. 5 are identical or similar and have been assigned the same numbers, for which reason they will not be explained in greater detail.

There are numerous possible variants of the examples shown in the present invention. Purely by way of example, tubes made from an insulating material might be used in order to avoid the use of insulators -29-, -39-.

Although the invention has been described with respect to examples of preferred embodiments, these must not be considered to be limitative of the invention, which will be defined by the broadest interpretation of the following claims.

1. Cantilever for overhead lines comprising: a main cantilever beam having a proximal portion, a distal portion, and a distal end, the distal end receives securing elements for securing the wires of the overhead line, and a diagonal beam supporting the main cantilever beam and inclined in relation to the main cantilever beam, characterised in that:
the main cantilever beam is telescopic and the proximal portion and the distal portion can move telescopically in relation to one another;
the securing elements for the wires of the overhead line are fixed in the distal portion of the main cantilever beam;
the diagonal beam is connected to the horizontal beam by a rotatable coupling and;
the diagonal beam is also telescopic.

2. The cantilever for overhead lines according to claim 1, characterised in that the distal portion of the main cantilever beam can slide freely inside the proximal portion, the main cantilever beam being provided with an adjustment device that allows the position of the distal portion of the beam to be fixed within a continuous spectrum of adjustment positions.

3. The cantilever for overhead lines according to claim 2, characterised in that the adjustment device comprises a groove in the proximal portion of the main cantilever beam and at least one bolt that passes through the said groove and makes contact with the distal portion of the main cantilever beam.

4. The cantilever for overhead lines according to claim 3, characterised in that the bolt is inserted into a threaded hole in the distal portion of the main cantilever beam.

5. The cantilever for overhead lines according to claim 4, characterised in that the threaded hole is located in a piece in the end of the distal portion of the main cantilever beam.

6. The cantilever for overhead lines according to claim 3, characterised in that the adjustment device comprises a sleeve that shrouds the proximal portion of the main cantilever beam, with the ability to slide along the main cantilever beam.

7. The cantilever for overhead lines according to claim 3, characterised in that the adjustment device further comprises a locking joint ring or washer to fit the head of the bolt.

8. The cantilever for overhead lines according to claim 1, characterised in that the securing elements of the wires of the overhead line are joined to the distal portion of the main cantilever beam at dedicated and unique points of the distal portion of the main cantilever beam.

9. The cantilever for overhead lines according to claim 1, characterised in that the distal portion of the main cantilever beam has a ganging scale that indicates the offset of the overhead line with respect to the axis of the guide.

10. The cantilever for overhead lines according to claim 1, characterised in that the main cantilever beam and the proximal beam are joined to a fixed structure by electrical insulators.

11. The cantilever for overhead lines according to claim 1, characterised in that the diagonal beam is joined to the proximal portion of the main cantilever beam.

12. The cantilever for overhead lines according to claim 1, characterised in that the diagonal beam is joined to the distal portion of the main cantilever beam.
